(19) United States
(12) Patent Application Publication
(10) Pub. No.: US 2008/0018741 A1
(43) Pub. Date: Jan. 24, 2008

(54) Transmission Of Image Data During Application Sharing

(75) Inventors: Andre Stork, Erzhausen (DE); Pedro Santos, Muenster (DE); Dominik Acri, Gaggenau (DE)

Correspondence Address: COHEN, PONTANI, LIEBERMAN & PAVANE, 551 FIFTH AVENUE, SUITE 1210, NEW YORK, NY, 10176, US

(73) Assignee: Fraunhofer-Gesellschaft zur Forderung der angewand, Muenchen (DE)

(21) Appl. No.: 11/632,103

(22) PCT Filed: Jun. 30, 2005
(86) PCT No.: PCT/EP05/07283

§ 371 Date: May 24, 2007

(30) Foreign Application Priority Data
Jul. 11, 2004 (DE) 10 2004 033 766.7

(51) Int. Cl. H04N 5/225

(52) U.S. Cl. 348/207.1; 348/E05.024

(57) ABSTRACT

The invention relates to the transmission of image data during which first image data are continuously generated by a first computer (PC1) and are or can be displayed in the form of a first temporal sequence of first images on an image display device of the first computer. At least a partial number of the first images are continuously acquired and corresponding second image data are generated therefrom and transmitted to a compression device (CO). The second image data are compressed by the compression device for a data transmission whereby resulting in the generation of third image data, whereby second image data are continuously taken into consideration during compression that correspond to a portion of the first sequence with a number of the first images. The third image data are output to a data transmission device (PR) that generates data transmission signals corresponding to the third image data. As a result, after the data transmission signals are received and after a decompression (DEC) effected by a second computer (PC2), a second temporal sequence of second images that corresponds to the third image data can be generated that, with regard to the continuous generation of the first image data, can be displayed in real time. Items of control information sent from the second computer (PC2) are received by the data transmission device (PR) and used for controlling the operation of the first computer whereby influencing the generation of the first image data.

The invention pertains to a method and an arrangement for the transmission of image data, where some or all of the image data are generated by at least one application (computer program) running on a first computer, especially on a conventional personal computer (PC). The image data can be or are shown on an image display device of the first computer as a sequence of images. In addition, as part of a process of application sharing, images which correspond to the image data generated on the first computer are also shown on an image display device of a second computer. The minimum of one application can be controlled by control signals, so that the generation of subsequent image data can be influenced. These control signals are generated or initiated by a user of the second computer.

In the case of application sharing, at least one application runs on the first computer, at least some of the results of which are intended to be available on a second computer or some other device (which is independent of the first computer and in a location remote from it). The actual application is therefore not running on the second computer or other device. As a rule, therefore, no license fees have to be paid to run the application on the second computer or other device. Another advantage of application sharing is that the second computer or the other device does not have to be set up to run the application. For example, the data required to run the application do not need to be present and/or the same computing power as present in the first computer does not need to be available. It is therefore also possible to make the results of the application available to a plurality of second computers and/or other devices, namely, either selectively and/or in chronological succession. In this specification, the term “second computer” is always used to mean the “other device”. The “other device” is, for example, a workstation, which has all the conventional operating and display elements of a computer but in which only limited computing power is available, or a computing device set up especially to run the operating and display elements. In particular, however, the “other device” is intended to have the ability to receive the data transmission signals and to display the corresponding images.

There is currently no application sharing system by means of which images which represent the movement of objects can be displayed satisfactorily at the color depth conventional today of at least 16 bits and at resolutions of at least 800×600 pixels on the image display device of the second computer, so that a user of the second computer can control in real time the application running on the first computer. In particular, in the case of graphics processing applications, e.g., CAD (Computer Aided Design) and CAS (Computer Aided Styling), it important that the user be able to see the movement continuously and without noticeable time delay. If the user cannot see the movement continuously and without delay, he would, under certain conditions, be likely to give control commands (e.g., control commands generated by means of a mouse) which no longer correspond to the actual execution status of the application.

The present invention is based on the task of providing a process and an arrangement of the type indicated above which make application sharing possible in such a way that image data can be displayed with high quality on an image display device of the second computer. In particular, the goal is to provide an application sharing system which has the features described in the preceding paragraph, namely, a high local resolution, a narrow required bandwidth of the communications link between the first computer and the second computer, the ability to show, in real time, the images generated by the first computer on the second computer, and a high image refresh rate.

A process for the transmission of image data is proposed, where

(a) a first computer continuously generates first image data, which are or can be displayed on an image display device of the first computer as a first chronological sequence of first images;

(b) at least a subset of the first images is captured continuously, from which corresponding second image data are generated and transmitted to a compression device;

(c) the second image data are compressed by the compression device for data transmission, so that third image data are created, where, during the compression, second image data which correspond to a subset of the first sequence consisting of a plurality of first images are taken continuously into account;

(d) the third image data are sent as output to a data transmission device, which generates data transmission signals corresponding to the third image data, so that, after reception of the data transmission signals and after a decompression by a second computer, a second chronological sequence of second images corresponding to the third image data can be generated, which, relative to the continuous generation of the first image data, can be displayed in real time; and

(e) control information transmitted by the second computer is received by the data transmission device and used to control the operation of the first computer, so that the generation of the first image data is influenced.

It is not necessary for the first images to be captured at the same frequency conventionally used as the image refresh frequency of modern computer monitors. Instead, it is sufficient for the application sharing to capture, for example, 15 first images per second and to generate from them the second image data.

“Real time” is understood to mean that the second sequence of images can be generated within a defined period of time. In particular, a length of time can be defined which, in terms of an image, begins with the continuous generation of the first image data or with the display of the first chronological sequence of images and within which at least the capture of the image, the compression of the second image data, and the data transmission are completed. The length of the time period is preferably set at a value which allows the observer to perceive only slight differences between the display of the first sequence of images and the display of the second sequence of images or so that the time difference between the displays is the same as for other remote data transmissions (e.g., the transmission of acoustic signals during a telephone conversation). A short time difference of this type for the displays is a decisive advantage of application sharing.

“Real time” is also understood to mean in particular that the second sequence of images can be displayed continuously for viewing with the same time delay or with the same maximum time delay with respect to the generation or display of the first sequence of images.

According to an essential idea of the present invention, during the compression, second image data which correspond to a subset of the first sequence consisting of a plurality of first images are taken continuously into account. As a result of the plurality of first images, which are taken into account in the compression of the second image data, the compression can be executed more effectively and with a higher degree of compression. In particular, it is possible to take into account the developments which occur over time as the image contents change.

The “plurality” of images can be two images. Preferably, however, more than two images (that is, many images) can be taken into account continuously during compression (especially at many different times during the compression process), e.g., four to eight images. Exceptions to this can be made temporarily and repeatedly so that, for example a so-called keyframe or I-frame (an image consisting of data which are independent of other images) can be transmitted. The number of images which are taken into account during compression can change and/or fluctuate over the course of time.

It preferable for the second image data to be compressed in a “lossy” manner, depending on the content of the second image data. Optionally, the lossy compression of the second image data can also be carried out as a function of the data transmission capacity of the signal transmission which is available.

In particular, one or more of the following measures can be applied during the compression process:

Information concerning objects which move during the first chronological sequence of images is transmitted with higher local resolution and/or at greater color depth than static parts of the images. It is preferable to reduce only the color depth and/or to reduce the color depth to a greater extent than the local resolution. This conforms to the ability of the human eye to resolve brightness differences more effectively than color differences.

Information concerning objects which move against a background is extracted from the sequence of images, and at least some of this information is transmitted separately.

Wavelet transformation is used during the compression process.

The compression is adjusted dynamically to the data transmission rate.

At least some of the information concerning partial contents of images which remain constant in the first chronological sequence over a given period of time is eliminated by the compression.

Statistical information concerning the contents of individual images and/or the contents of a plurality of images in the first sequence of images is used for compression. For example, it is possible here to use correlations between temporally (i.e., occurring in different images) and spatially (i.e., occurring in the same subarea of one or more images) adjacent pixels. In particular, image structures which occur at a higher statistical frequency can be encoded by the use of shorter code words (i.e., data structures with fewer data bits) than image structures which occur at a statistically lower rate.

A cosine transformation (especially a forward-oriented, discrete cosine transformation) is used to determine the subareas of images to which a greater data capacity should be allocated during transmission.

During the compression process, information is generated which can be used on the receiving side (after decompression) to calculate images lying chronologically between other images or lying chronologically in the future. When the information is being generated, a search can be made in particular for partial images which have not changed or will not change versus chronologically adjacent images. Another concrete application takes advantage of the fact that moving objects usually move continuously over a certain period of time and move in a consistent manner (so-called “motion prediction”). This situation occurs frequently in graphics processing applications.

In particular, the compression can be carried out according to the MPEG-4 standard (MPEG=Moving Picture Experts Group). The MPEG-4 standard was developed to compress audio and video data for storage on CD-ROMs and DVDs and for digital television. The present invention is based on the realization that a compression of this type is suitable for application sharing. This meets the requirements of professionals in the field, who prefer that loss-free compression be used in application sharing, that is, that the information contained in the transmitted signals should not be reduced. The invention, however, is not limited to MPEG-4. On the contrary, compression according to the MPEG-2 standard can also be implemented.

The computing work required for decompression on the receiving side is usually less than that required for compression. An advantage is therefore to be found in the fact that the second computer does not have to be as powerful as the first computer.

In a special embodiment of the invention, an application running on the first computer generates graphically displayable objects, at least for certain periods of time, which move continuously and/or are three-dimensional, where the objects or the movements are or can be displayed by the first sequence of images. In this embodiment, the inventive compression process, which considers a plurality of first images, has been found to be especially effective. In particular, lossy compression can be carried out without the user of the second computer perceiving a significant reduction in the quality of the display. This pertains above all to image data from time periods in which the user himself causes the object to move and/or causes a change in the object (for example, by the use of a pointing device). Especially for this purpose, various image areas of the same image and/or various images of the sequence of images are compressed to different local image resolutions and/or movement prediction is used during compression.

The first image data are in particular image data which are intended for display on a screen. In contrast to systems in which the first image data are sent to the computer (e.g., by an external camera), the first image data are generated by the first computer itself, especially by one or more applications. A plurality of computer programs can be running simultaneously and/or quasi-simultaneously on the first computer under the administration of, for example, a screen-based operating system such as Windows® from Microsoft Corporation, Unix, or Linux.

A preferred embodiment of the invention is especially designed for use on computers with operating systems of this type. For example, the first images, which are the result of several computer programs running on the first computer, are captured continuously, and corresponding second image data corresponding to these first images are transmitted continuously to the compression device. The second image data can be stored in particular in the main working memory (usually RAM).

The first images preferably correspond to what is displayed on the screen assigned to the first computer. In the case of Windows, for example, this screen shows the Desktop and/or the contents of the active windows. The continuous capture of the first images therefore generates in particular a chronological sequence of screen shots. During the further processing of the second image data, however, one or more individual parts (e.g., subframes) of the first images can also be cut out and/or isolated from the first images, and this part or these parts can be compressed and transmitted by the data transmission signals.

In a preferred embodiment, the first images are captured continuously by an image capture program running on the first computer, and the second image data are generated from them. In principle, hardware such as a frame-grabber card can be used for this purpose. The use of an image capture program (i.e., of software), however, offers the advantage that the first computer can be set up easily and cheaply for the inventive capture of the first images. In addition, commercially obtainable frame-grabber cards are not suitable, without further measures, for capturing images on the computer in which they are installed. Instead, they serve to capture images from external applications or devices (e.g., video devices, web cameras, video cameras).

The image capture program is in particular an application program which works independently under the operating system and uses only the interfaces to the operating system available to any application program (e.g., in contrast to application programs which use DirectX interfaces under the Windows operating system). In particular, the first computer can be a standard commercial Personal Computer (PC), the central processor unit (CPU) of which executes the image capture program. The image capture program can run in quasi-parallel with other applications. Application sharing with the inventive image transmission is therefore possible with a standard commercial PC (e.g., with a Pentium-4 processor as CPU at a clock frequency of 3 GHz). In an exemplary embodiment of the invention, standard commercial PCs are used in this way to achieve transmission rates of at least 25 images per second at a resolution of 800×600 pixels and at a color depth of 16 bits. Higher image resolutions can also be achieved.

The image capture program can be a program which can be executed independently of the application program (e.g., the graphics program) which generates the first image data. The image capture program is therefore not integrated into the application program. This offers the advantage that the image capture program can capture the image data of any desired application program and that the application programs themselves do not have to be modified.

In an especially preferred embodiment of the image capture program, the image information on the first images which is used is the information made immediately available by the operating system of the first computer. This image information contains the following data:

the image properties of the first image in question, especially the image size, the local image resolution, the color depth, and/or the image format;

the memory address and/or a pointer to the memory address of the image data memory, under which the image data of the first image in question are stored or by way of which the memory location of the image data can be found.

Instead of the memory address (or the pointer), it is possible to use a procedure made available by the operating system, which gives access to the image data of a certain first image, especially the current image, for output on a screen. The image data are preferably in a pixel-based format (e.g., bitmap or pixmap).

An “image” in the present specification is understood to be in particular the totality of image data containing the complete set of information which specifies how a corresponding visible image is to be shown on an image display device. For example, the totality of image data for an image in a pixel-based image format contains complete information on the color value and brightness of each individual pixel.

In the present invention, as previously mentioned, data transmission signals containing the corresponding information concerning the first image data are sent from the first computer to the second computer. There also exists, however, the possibility of sending control information from the second computer back to the first computer (over one or more additional channels of the same data communications link, for example) to control the application. It is possible for the second computer to send to the first computer the second computer user's commands, especially keyboard commands and/or commands of a pointing device (e.g., a mouse), as control information, by which the application is controlled.

Optionally, additional information concerning results and/or the status of the application can also be transmitted from the first computer to the second computer. For example, information on acoustic signals can be transmitted over an additional channel (in one or both directions), where the acoustic signals are intended to be played audibly in synchrony with parts of the sequences of images (for example, by a speaker connected to the computer). It also possible, however, for the acoustic signals to be transmitted in synchrony with the first sequence of images over the same transmission channel as that carrying the image data. For example, the acoustic signals can be compressed by the same compression device as that which compresses as the image data.

The second sequence of images does not have to be identical to the first sequence of images. For example, when the images are captured, individual images can be left out and/or the image data which are transmitted can be reduced by some other means.

The data transmission signals can be transmitted over a remote communications link, e.g., a data line of a computer network and/or a DSL data connection, to the second computer. At least certain sections of the link, such as the last section just before the second computer, can be designed as a wireless signal transmission connection (e.g., wireless LAN).

Control signals are preferably transmitted repeatedly by the first computer along with the data transmission signals.

The control signals can be set up in such a way that, on the receiving side (i.e., on the second computer side), it can be determined whether the control signals and thus the actual data transmission signals are being received in the correct chronological order. On the basis of the control signals, the second computer can determine, for example, whether individual data packets are being received after other data packets that were transmitted later. In this case, the second computer can decide to discard the data packets that were received too late or to sort them on the basis of their time signatures and if possible to use them to construct the image.

Alternatively or in addition, the control signals or corresponding reply signals can be sent back from the second computer to the first computer. This makes it possible for the first computer to determine that certain portions of the data transmission signals originally sent by it have at least with a high degree of probability reached the second computer.

In a preferred embodiment, the control signals are transmitted from the first computer at regular time intervals and/or have different time information. On the basis of the time information, the first computer can determine at what time and/or at what time interval with respect to each other the control signals were generated or sent by the first computer. “Time information” is also understood to be information on the specific control signal involved. In this case, the first computer can, through evaluation of additional information, determine when the control signal was generated or transmitted or how much time has passed since the time that the signal was sent or generated.

Preferably not every control signal (or the corresponding reply signal) received by the second computer is sent back to the first computer, because returning all of them would unnecessarily increase the amount of data being transmitted from the second computer to the first computer.

As a function of the evaluation of the returned control signals or of the received reply signals, the first computer can change the compression rate for the compression of the second image data and/or the data rate of the third image data produced as output by the compression device. In this way, the compression of the second image data can be adapted to changes in the transmission conditions between the first and second computers. In particular, it is possible to prevent the compression process from generating amounts of data so large that they cannot be transmitted at all or not transmitted in a reasonable period of time. For example, it is possible to define an upper limit for the length of time between the generation or transmission of a control signal by the first computer and the reception of the reply signal or the return of the control signal to the first computer. If the upper limit is exceeded once or several times, for example, the compression settings can be adjusted. Accordingly, a lower limit can also be defined for the length of time. If the length of time falls below the lower limit once or several times, for example, the compression rate can be increased and/or the data transmission rate of the compressed data can be increased. Alternatively to the lower limit, the data transmission rate and/or the compression rate can also be increased when the upper limit is not reached or not exceeded.

In particular, a transmission device of the first computer, which converts the third image data according to a transmission protocol (e.g., the User Datagram Protocol—UDP, which will be discussed further below) to the data transmission signals, generates the control signals and evaluates when the corresponding reply signals or the returned control signals arrive from the second computer.

The application sharing is not limited to the case that a single computer receives the data transmission signals and generates and displays corresponding second images. On the contrary, a plurality of second computers (devices which do not themselves run the application) can be operated simultaneously. The application can also be controlled by several second computers, where in each case the corresponding control information is sent to the first computer.

In addition to the previously described method for transmitting image data, an arrangement is also proposed which can be designed to implement the method in one of its described variants. In particular, the arrangement for transmitting image data has:

(a) a first computer, in which an application is stored, which, when run by the first computer, is designed to generate first image data continuously, which can be shown as a first chronological sequence of first images on an image display device of the first computer;

(b) a capture device, which is connected to the first computer or is part of the first computer and is set up to capture continuously at least a subset of the first images and to generate from them corresponding second image data and to transmit them to a compression device;

(c) the compression device, which is connected to the capture device and is set up to compress the second image data for data transmission, so that third image data are created, where, during the compression process, second image data which correspond to a subset of the first sequence consisting of a plurality of first images are taken continuously into account;

(d) a transmission device, which is connected to the compression device and is set up to output the third image data to a data transmission device, which generates data transmission signals corresponding to the third image data; and

(e) a receiving device, which is connected to the first computer or is part of the first computer and which is set up to receive from the data transmission device control information sent by a second computer, where the first computer is configured to use the control information to control the operation of the application, so that the generation of the first image data is influenced.

The compression device can be configured in particular to carry out a lossy compression of the second image data during the compression process as a function of the content of the first images.

For example, the compression device is designed as an application program which runs on the first computer. In particular, the compression program can be executed by the processor (e.g., the CPU) of the first computer. Thus the first computer must have considerable computing power. This is especially true when, in addition to the compression program and the application program which generates the first image data, the first images are also captured by the same processor. Experiments have shown, however, that a standard commercial PC is equal to the task. The previously mentioned transmission rates of at least 25 images per second can be achieved at a resolution of 800×600 pixels and at a color depth of 16 bits. To lighten the load on the first computer, however, the compression device can, as an alternative, be realized at least in part in hardware in the form of, for example, a card configured for compression, which is connected to the bus system of the first computer.

In a special embodiment of the arrangement, the application program which realizes the compression device also comprises the capture device. The same computer program therefore controls both the capture of the first images and the compression of the second image data. Nevertheless, it is advisable for the second image data to be stored initially after their generation in their entirety in a storage unit of the computer and for the compression device to access these stored image data.

The capture device is preferably designed as an application program, which is stored on the first computer and which, when running, captures continuously at least a subset of the first images.

The arrangement can be contained completely in a Personal Computer.

A corresponding application sharing system with the described arrangement and with a second computer also belongs to the scope of the invention. The second computer has a receiving device for receiving the data transmission signals, a decompression device for decompressing the data transmission signals, and an image display device. The decompression device is configured to generate decompressed fourth image data from the data transmission signals. The second computer is configured to generate a second chronological sequence of second images from the fourth image data; this second sequence of second images corresponds at least to a subset of the first chronological sequence of first images and, relative to the continuous generation of the first image data, can be displayed in real time.

A preferred exemplary embodiment of the present invention is now described with reference to the attached drawing:

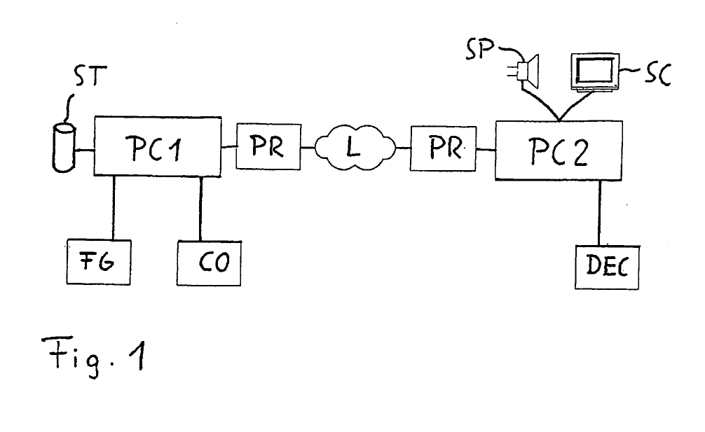

FIG. 1 shows an application sharing system according to the present invention;

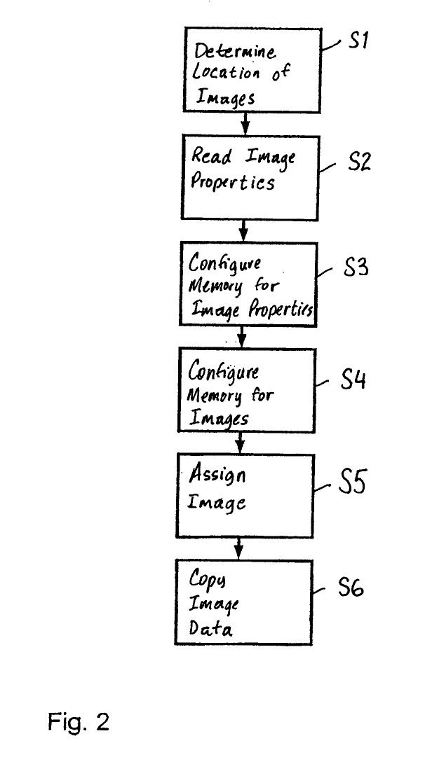

FIG. 2 shows a flowchart with a procedure for capturing an image; and

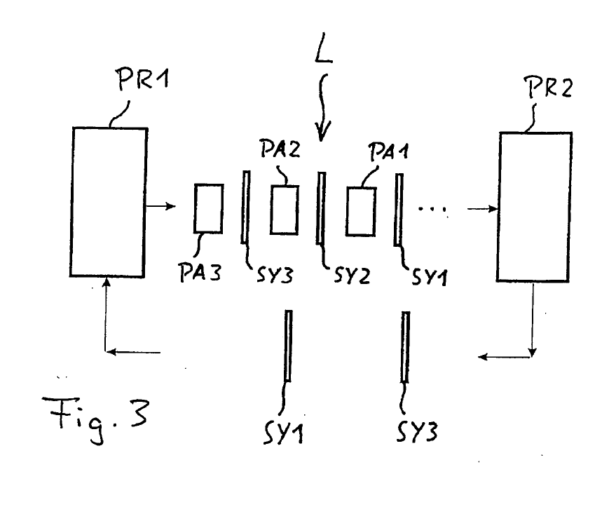

FIG. 3 shows a schematic diagram which illustrates the transmission and return transmission of control signals (sync marks).

FIG. 1 shows a first computer PC1, which is equipped with a working memory ST, an image capture device FG, and with a compression device CO. For example, this can be a standard commercial PC with an Intel Pentium 4 CPU (clock frequency of 3 GHz) or a similarly powerful Intel Centrino CPU, where the working memory ST is 512 Mbytes of RAM. The first computer PC1 also has a transmission device (not shown in FIG. 1) and a graphics card, which are also designated by the reference number PC1. The transmission device prepares image signals according to a communications protocol and transmits the corresponding transmission signals over a communications link L. In FIG. 1, the transmission according to the communications protocol is indicated symbolically by a block designated PR.

On the receiving side of the communications link L there is another block PR, which symbolizes the transmission according to the communications protocol. The communications link L ends at a second computer PC2, which is equipped with a decompression device DEC, with a speaker SP, and with a display screen SC. Although not shown in the figure, the second computer PC2 can also be equipped with conventional operating elements such as a keyboard, a mouse, a trackball, or a similar type of pointing instrument.

The application sharing system according to FIG. 1 is operated by way of example as follows: An application (such as a 3D graphics application) run by the central processor of the first computer generates continuously first image data as a function of control signals. The control signals are initiated by a user of the second computer PC2 by the use of a keyboard and/or the pointing instrument. In this way, the user of the second computer PC2 controls the application running on the first computer PC1. In particular, the first image data can create for the user a graphic display with a recognizable three-dimensional appearance. The display screen SC (and/or other image display means of the second computer PC2) can be configured correspondingly.

The first image data (possibly together with additional image data from other applications and/or image data from the operating system) are converted by the operating system and the graphics card of the first computer PC1 into a first sequence of images, which can be displayed on a screen (not shown in FIG. 1) of the first computer PC1. Individual examples of these first images from the graphics card are captured continuously by the image capture device FG and stored in the working memory ST. The compression device CO accesses a plurality of these second image data, compresses them, and thus reduces the quantity to data to be transmitted. By the use of the MPEG-4 standard, compression rates of, for example, 1:40 can be achieved currently, where, in spite of the lossy compression, high image qualities can nevertheless be obtained.

The data transmission signals generated by the compression device CO are sent as output to the transmission device, which generates transmission signals from them according to the communications protocol. These signals are then transmitted over the communications link L.

The signals are received by the second computer PC2 and sent according to the communications protocol to the decompression device DEC, which generates from them the fourth image data. Image data are now present, therefore which correspond to the first image data, although the time resolution is usually not as high. From the fourth image data, the second computer PC2 generates a second sequence of (second) images, which are shown on the screen SC. If desired, audio signals synchronized with the image data are also received by the second computer PC2, decompressed, and produced as output by the speaker SP in synchrony with the second images.

The preferred communications protocol is the User Datagram Protocol (UDP). Like the Transport Control Protocol (TCP), UDP is located in layer 4 of the Open System Interconnection Standard (OSI). UDP is used here in conjunction with the Internet Protocol (IP, in layer 3 of the OSI). In comparison to TCP, in which the reception of each received data packet is confirmed individually, higher transmission rates can be achieved with UDP, and the delay until the data signals arrive at the receiving side is also shorter.

UDP itself is independent of the communications link. Because no check is made on the transmission side to determine whether a receiver even exists or whether the receiver is actually receiving the data packets, pace can be kept with progressive changes in the image content of the first images even if there are problems with the communications link. For application sharing, it is acceptable to trade this off against the possibility that some of the image data generated by the compression device may be lost.

An application which uses UDP for communications must itself determine to what extent errors have occurred in the transmission and, as needed, to respond to that. Because UDP does not offer the security which TCP offers, it can be used to exchange data very quickly between two computers.

FIG. 2 shows a flowchart, on the basis of which a preferred embodiment of a procedure is to be described. With this procedure, a single image within the set of first images can be captured on the basis of the image data. When the capture procedure is repeated in order to capture additional images of the first sequence of first images, it is possible, under certain conditions, to leave out certain of the individual steps of the following series. Such conditions exist when, for example, the corresponding information from an earlier run and/or from an initialization of the capture procedure is still present:

Step S1: Determination of the location where the image properties are stored, and/or determination of equivalent information, by the use of which access can be gained to the image properties (under Windows® from Microsoft Corporation—referred to below in the following as “Windows”, the step is executed, for example, by means of the function “GetDesktopWindow”, which returns a pointer, that is, an address pointer to the memory location of the image properties);

Step S2: Read-out of the image properties required for the capture of the first image, especially the image size (under Windows, the step is executed, for example, by means of the function “GetDC”);

Step S3: Setup (especially the reserving of memory space) of a memory structure for the image properties of the first image to be captured (under Windows, the step is executed, for example, by means of the function “CreateCompatibleDC”);

Step S4: Setup (especially the reserving of memory space) of a memory structure for the image data of the first image to be captured (under Windows, the step is executed, for example, by means of the function “CreateCompatibleBitmap”);

Step S5: Assignment of the first image to the captured to the setup memory structures (under Windows, the step is executed, for example, by means of the function “SelectObject”); and

Step S6: Copying of the image data of the first image to be captured to the setup memory structure.

Under the Windows operating system, the previously described configuration of the capture procedure has proven to be very fast, especially in contrast to application programs which use interfaces to DirectX for the same purpose. Therefore, the inventive image capture program can run on a standard PC (Personal Computer), without the CPU (Central Processing Unit) being too heavily burdened. The CPU can thus fulfill its primary tasks, namely, the execution of the running application programs, without interference or delays. This is an important precondition for application sharing which will be acceptable to users.

FIG. 3 shows a first transmission device, designated PR1, of the first computer, such as the first computer PC1 according to the arrangement of FIG. 1. The transmission device PR1 is connected to a second transmission device PR2 of the second computer PC2 via the communications link L. The transmission devices PR1, PR2 execute operations in accordance with a communications protocol (especially UDP via IP) to generate data transmission signals from image data or conversely to generate image data from data transmission signals. As a result, data packets PA and control signals are transmitted via the communications link L, where the control signals are designated in the following as sync marks SY. The data packets PA and the sync marks SY are transmitted from the first computer to the second computer (from left to right in the diagram). Only individual sync marks SY are sent back from the second computer to the first computer (from right to left in the diagram), not the associated data packets PA, over a communications channel of the same communications link L available for data transmission in the opposite direction.

Three data packets PA1, PA2, and PA3 are shown overall in FIG. 3 as representatives of a continuous stream of data packets. One of the sync marks SY1, SY2, SY3 is assigned to each of the data packets PA1, PA2, PA3 (e.g., as a component of the data packet, such as in the data packet header). In the exemplary embodiment described here, the data packets are sent by the first computer at a constant transmission rate as long as the transmission rate is not being adjusted to the transmission conditions.

When the second transmission device PR2 has received one of the data packets PA1, PA2, PA3, with the sync marks SY1, SY2, SY3, it decides whether the sync mark SY1, SY2, or SY3 is to be sent back to the first transmission device PR1. In the example shown here, the sync mark SY1, SY3 of every second received data packet PA1, PA3 is sent back. In practice, it has been found advisable to send back fewer than the sync marks of every second received data packet and to send back, for example, the sync mark of every tenth received data packet.

Alternatively, the second transmission device PR2 can, for example, determine whether the sync mark in question is to be sent back exclusively on the basis of a continuous numbering of the data packets or exclusively on the basis of the sync marks. In particular, in this case a sync mark is sent back only when it is assigned to a second or a tenth (generally, an “n-th”, where “n” is a natural number) data packet (or a whole-number multiple of 2, 10, or n) in the sequence of data packets.

On the basis of the sync marks returned to it, the first transmission device PR1 checks to see how much time has elapsed since the transmission or-generation of the sync mark in question. The transmission frequency of the data packets can be used in particular for this purpose. Alternatively or in addition, the information concerning the serial number of the assigned data packet to be derived from the sync mark can be used to determine when the data packet was transmitted (or generated) or how much time has elapsed since then.

On the basis of the result of this check, the first transmission device PR1 decides whether the rate of the third image data generated by the compression of the second image data is adapted to the current communications conditions. The check and the decision can be carried out continuously, for example, at regular intervals, or at the beginning of an application sharing.

An exemplary embodiment of a configuration of the compression device and of the corresponding decompression device is now described. The exemplary embodiment was executed on a computer running the Windows operating system.

The compression is carried out according to the MPEG-4 standard. For the definition of this standard, see the document ISO/IEC JTC1/SC29/WG11-N4668 entitled “MPEG-4 Overview—(V.21—Jeju Version)” of March 2002.

MPEG-4 specifies various profiles for the encoding of video material, e.g., so-called “simple profiles” and “advanced real-time simple profiles”. The profiles are used so that the various features of MPEG-4 can be used with maximum efficiency. The profiles limit the tools which are available to a compression device to achieve the best possible quality for specific areas of application. These profiles have one or more subdivisions, which are called “levels” and which can be combined in any desired way. Corresponding profiles also exist for the MPEG-2 standard.

None of the existing profiles has proven advantageous for application sharing. Therefore, a solution without profiles was used, a (so-called “unrestricted”) implementation of the XviD codec (compressor/decompressor), Version 1.0.1. XviD is a result of an Open Source Project, which is described, for example, at the official web site of the Project (http://www.xvid.org/). The codec has a number of features which can be activated or deactivated or set during the compression or decompression of the image data. The features of the XviD codec are described in, for example, the document “XviD Options Explained, Maintained by Koepi (de_koepi@lycos.de)”, which is available at the Internet address http://nic.dnsalias.com/XviD_Options_Explained.pdf.

The feature “Motion Search Precision” is set at “6—Ultra-High”. This feature defines the precision with which a search should be conducted for moving objects in the sequence of the first images. By experiment, it was found that increasing the precision of the search for movement in the images achieves much better results and that only a small amount of additional computing power is required for this.

In the sharing of office application programs (such as the applications offered by Microsoft Corporation under the name “Office”), it was also found that better image quality could be obtained by activating “Cartoon Mode”. This mode was developed for animated cartoons, but it also turned out to be especially effective at compressing large monotone areas of the Desktop.

“VHQ mode” was deactivated, because the gain in quality was out of proportion to the additional load on the processor.

The compression device should force the transmission of an I-frame when there are major changes in the image content in the chronological sequence of images. An I-frame (I=internal) is an image whose image data are independent of the image data of the following and preceding images. Because it was found experimentally that this was not always done reliably, the feature “Maximum I Interval” was adjusted dynamically, namely, as a function of the images to be transmitted per second to the second computer. This image transmission rate is in particular identical to the rate at which images are captured from the sequence of first images.

In an embodiment of the invention, this image transmission rate depends on the computing power available on the first computer at the moment in question for the capture of the first images and for their compression (especially the computing power of the CPU). The larger the number of images to be transmitted per second, the higher the value for “Maximum I Interval” can be set. At an image transmission rate of 20-25 images per second, a default value of 300 images until the transmission of the I-Frame has been found effective. At slower image transmission rates, this value must be decreased. It should not, however fall below a value of 25 images before the transmission of the next I-Frame. It must be remembered here that a low value reduces the quality of the images shown on the image display device of the second computer, because the transmission of an I-Frame involves the transmission of a large quantity of data, which leaves only a small quantity of data available for the other images.

In a special embodiment of the invention (which is independent of the exemplary embodiment described above), the application which generates the first image data (e.g., a 3D graphics application) carries out a test after it starts. This test determines the speed at which an image is captured by the capture device and is compressed by the compression device. The application then determines the value for the number of images until the transmission of the next I-Frame. This value is adjusted dynamically to major changes.

The “target bit rate” is adjusted as a function of the available bandwidth of the data communications link or of the available data transmission rate. The user can determine this value himself, or the value can be determined automatically in the background on the basis of a bandwidth measurement or a measurement of the data transmission rate (e.g., by the compression application, designed as a computer program).

To the extent that settings of the features and/or the options of the XviD codec have not been described explicitly here, these settings correspond to the values and/or definitions preset in the codec (defaults).

1.-16. (canceled)

17. A method for transmitting image data, comprising the steps of:
continuously generating, by a first computer, first image data which are displayed or are displayable on an image display device of the first computer as a first chronological sequence of first images;
continuously capturing at least a subset of the first images and generating corresponding second image data from the at least a subset of the first images;
transmitting the second image data to a compression device and creating third image data by compressing the second image data for data transmission using the compression device, wherein the second image data correspond to a subset of the first chronological sequence of first images and consist of a plurality of first images which are taken continuously into account during the step of compressing;
outputting the third image data to a data transmission device which generates data transmission signals corresponding to the third image data such that a second chronological sequence of second images corresponding to the third image data can be generated from the data transmission signals by a second computer and displayed in real time relative to the continuous generation of the first image data after reception and decompression of the data transmission signals by the second computer;
transmitting, by the second computer, control information; and
receiving the control information, by the data transmission device and using the control information to control the operation of the first computer such that the generation of further first image data is influenced by the control information.

18. The method of claim 17, wherein said step of outputting further comprises transmitting the data transmission signals over a remote data transfer link to the second computer.

19. The method of claim 17, wherein said step of outputting further comprises transmitting the data transmission signals over a data communications link to the second computer and then decompressing the transmitted data transmission signals to form fourth image data, and wherein the second computer generates a second chronological sequence of second images from the decompressed fourth image data and displays them in real time on an image display device.

20. The method of claim 19, wherein said step of outputting further comprises repeatedly transmitting control signals to the second computer along with the data transmission signals, and sending, by the second computer, at least some of the control signals or corresponding reply signals to the first computer, said method further comprising the step of determining, by the first computer, whether to change at least one of a compression rate for compression of the second image data and a data rate of the third image data based on the returned control signals or reply signals.

21. The method of claim 17, wherein said step of compressing the second image data is performed with a loss of image data.

22. The method of claim 17, wherein said step of continuously capturing comprises continuously capturing the at least a subset of first images by an image capture program running on the first computer.

23. The method of claim 22, wherein the image capture program and at least one application program which generates the first image data are executed simultaneously or quasi-simultaneously by a central data processor on the first computer.

24. The method of claim 17, wherein each first image corresponds to the entire image content of a screen on the image display device of the first computer.

25. The method of claim 17, wherein said step of continuously capturing uses image information for the first images which is made available directly by an operating system of the first computer, the image information contains the image properties of the first images, the image properties including at least one of the image size, the local image resolution, the color depth, the image format, and a memory address or a pointer to a memory address of an image data memory, and wherein the image data of the first images to be captured are stored at the memory address or the memory location of the image data in the image data memory pointed to by the pointer.

26. The method of claim 17, wherein the first image data represent at least one moving three-dimensional object, and wherein the three-dimensional object is generated by an application running on the first computer.

27. The method of claim 17, wherein the first image data are suitable for being shown three-dimensionally on the image display device of the first computer by two parallel first chronological sequences of first images, and wherein first images of both first sequences are captured, compressed, and transmitted as data transmission signals, so that images corresponding to the first image data can be shown three-dimensionally on the image display device of the second computer in real time.

28. An arrangement for transmitting image data, comprising:
a first computer storing an application designed to be run by the first computer to continuously generate first image data which is displayable as a first chronological sequence of first images on an image display device of the first computer;
a capture device connected to or part of the first computer configured to capture continuously at least a subset of the first images and to generate corresponding second image data from the at least a subset of the first images;
a compression device connected to the capture device, said capture device configured to transmit the second image data to said compression device, and said compression device being configured to compress the second image data for data transmission, thereby creating third image data, the second image data which correspond to a subset of the first sequence consisting of a plurality of first images are taken continuously into account by said compression device for forming the third image data;
a transmission device connected to the compression device and configured to output the third image data to a data transmission device which generates data transmission signals corresponding to the third image data; and
a receiving device connected to or part of the first computer, said receiving device configured to receive from the data transmission device control information sent by a second computer, wherein said first computer is configured to use the control information to control the operation of the application and influence the generation of the first image data.

29. The arrangement of claim 28, wherein the compression device is configured to compress the second image data with a loss of image information as a function of the contents of the second image data.

30. The arrangement of claim 28, wherein the capture device is configured as an application program stored on the first computer, wherein execution of the application program captures continuously at least the subset of the first images.

31. A personal computer comprising the arrangement of claim 28.

32. An application sharing system comprising the arrangement of claim 28 and a second computer, wherein the second computer includes a receiving device configured to receive the data transmission signals, a decompression device configured to decompress the data transmission signals, and an image display device, wherein the decompression device is further configured to generate decompressed fourth image data from the data transmission signals, and wherein the second computer is configured to generate a second chronological sequence of second images from the fourth image data, which second sequence of second images corresponds to at least a part of the first chronological sequence of first images and which, with respect to the continuous generation of the first image data, can be shown in real time.
